(19) United States
(12) Patent Application Publication
(10) Pub. No.: US 2019/0322198 A1
(43) Pub. Date: Oct. 24, 2019

(54) SEAT VENTILATION DEVICE AND VENTILATED SEAT THEREOF

(71) Applicant: Shanghai MYLEE Auto Parts Co., Ltd., Shanghai (CN)

(72) Inventors: Xuping Shao, Shanghai (CN); Fei Li, Shanghai (CN)

(73) Assignee: Shanghai MYLEE Auto Parts Co., Ltd.

(21) Appl. No.: 16/379,785

(22) Filed: Apr. 9, 2019

(30) Foreign Application Priority Data
Feb. 12, 2018 (CN) 201810146560.6

(51) Int. Cl. B60N 2/56; B60N 2/58; B60H 1/00

(52) U.S. Cl. CPC B60N 2/5657; B60H 1/00564; B60N 2/58; B60N 2/5628

(57) ABSTRACT

Seat ventilation device and a ventilated seat thereof comprising a foam layer and a ventilating duct, wherein the air outlet of the ventilating duct is embedded in the bottom of the foam layer, and the air inlet of the ventilating duct is externally connected with a fan system.

### CROSS-REFERENCE TO RELATED APPLICATIONS

The subject application claims priority on Chinese patent application no. 201810146560.6 filed on Feb. 12, 2018 in China. The contents and subject matter of the Chinese priority application is incorporated herein by reference.

### FIELD OF TECHNOLOGY

The present invention relates to automobile seats, particularly, a seat ventilation device and a ventilated seat thereof.

### BACKGROUND ART

As the quality of life continues to prove, people have higher requirements for the ride comfort, among which the ventilation of the automobile seat is an important factor affecting the comfort of the automobile seat. Especially in the summer when the human body is prone to sweating or the weather is hot, the seat needs to be more conducive to the perspiration and refreshing of the driver's body surface. At present, some high-grade automobiles on the market already are equipped with the ventilation function. A conventional structure of a seat ventilation device is disclosed in Chinese Invention Patent CN103042960A showing a hollow fan structure area that is arranged in the sponge bearing cushion of the automobile seat, in which multiple axial flow fans are placed to achieve the purpose of ventilation. Another automobile ventilated seat structure is disclosed in the Chinese Patent No. ZL200720151433.2 showing that a H-type or U-type air duct is dug out on the foam surface of the cushion and the backrest of the automobile seat, the ambient air inside the car is sent to the air duct through the air inlet by the air supply device, and then the air duct is in contact with human body through the filter layer and the surface layer with a plurality of breathable holes of each seat cover to achieve heat exchange. These two ventilation devices cause great damage to the sponge cushion of the automobile seat, which may lead to the collapse of the cushion surface after a long time of use, and the installation is very complex and time-consuming, and the uneven outflow of air affects ride comfort. In addition to the common problems, CN103042960A has foreign body sensation and vibrating sensation at the fan, while ZL200720151433.2 has a large loss of air volume, which makes the terminal air volume small and increases the corresponding energy consumption.

### SUMMARY OF THE INVENTION

The present invention overcomes the deficiencies of the existing technology, and provide a seat ventilation device and a seat, which can reduce damage to the sponge cushion of the automobile seat, reduce the processing cost, overcome the problem of foreign body sensation and vibrating sensation, reduce air volume loss, increase the terminal air volume and reduces energy consumption.

To achieve the purposes described, the technical solution of the present invention is as follows: a seat ventilation device is characterized in that it comprises a foam layer and a ventilating duct, the air outlet of the ventilating duct is embedded at the bottom of the foam layer, and the air inlet of the ventilating duct is externally connected with a fan system.

In the present invention, the ventilating duct is an I-shaped cavity, an air inlet is arranged on one side of the I-shaped cavity, and a plurality of air outlets are arranged on the other side of the I-shaped cavity.

In the present invention, the air inlet is located in the middle of the I-shaped cavity, and the plurality of air outlets are evenly distributed on both sides of the I-shaped cavity.

In the present invention, the ventilating duct has a multi-claw shape and is composed of a route adapter and multiple branch pipes. The central side of the route adapter is provided with an air inlet, one end of the branch pipe is connected to the route adapter, the other end of the branch pipe is embedded in the bottom of the foam layer as the air outlet, and the air outlet and the air inlet are opposite in direction.

Preferably, in the present invention, the multi-claw shape is an eight-claw shape. A ventilated seat is characterized in that it comprises the seat ventilation device, a seat body leather cover layer, a 3D connecting layer and a fan system.

In the present invention, the 3D connecting layer is arranged between the foam layer and the seat body leather cover layer, and the 3D connecting layer is stitched with the seat body leather cover layer. The upper surface of the foam layer is fitted with the 3D connecting layer, and the fan system is connected with the air inlet.

In the present invention, the breathable holes are uniformly distributed on the seat body leather cover layer.

In the present invention, the fan system is connected with the air inlet through the semiconductor air conditioning module, and the air is heated and cooled to realize quicker increase or decrease of the temperature.

In the present invention, the 3D connecting layer is stitched with the seat body leather cover layer to uniformly disperse the air volume. The 3D connecting layer has a 3D structure, which ensures better ventilation property. The thickness of the 3D connecting layer is 1 mm-20 mm, and preferably, 5 mm-15 mm.

In the present invention, a heating layer is further arranged between the 3D connecting layer and the foam layer.

The number of the air outlets of the cushion and the backrest is 3-10 each, and the diameter of the air outlet is 5-20 mm.

In the present invention, the lower surface of the foam layer is provided with air holes adapted to the air outlet.

In the present invention, the foam layer is a PU foaming composite material.

In the present invention, the 3D connecting layer is a porous sponge with high permeability and high elasticity, or a porous nylon fabric with high permeability and high elasticity.

In the present invention, the lower part of the foam layer is compounded with a non-woven fabric to increase the strength of the foam layer and to cover the ventilating duct.

In the present invention, the ventilation system includes two modes, blowing and suction. Under the blowing mode, the air in the cockpit enters the embedded ventilating duct through the air inlet of the fan, and then enters the 3D connecting layer to circulate and ooze out of the seat surface to provide ventilation. Under the suction mode, the flow direction of the air is opposite to the flow direction of the air under blowing mode.

Compared with the prior art, the present invention is advantageous in that:

(1) By using foam layer structure with embedded duct, the production cost is greatly reduced, the loss of air volume is small, the energy consumption is reduced, the risk of collapsing of long-term use of the foam is avoided, and the comfort is improved by eliminating foreign body sensation and vibrating sensation.

(2) The ventilation area/ventilation point can be arranged flexibly, the ventilation position can be arbitrarily selected according to the need, the assembling is simpler and more convenient, and the compatibility with the support structure of the same seat frame itself is good.

(3) The 3D connecting layer is used for more permeability, so that the air volume is very well dispersed on the seat surface, and the ride comfort is better, and at the same time, it plays a supporting role to prevent the air outlet from being blocked due to being squeezed.

### BRIEF DESCRIPTION OF THE DRAWINGS

FIGS. 1A and 1B are schematic drawing showing the structure of a first embodiment of the seat ventilation device of the present invention, wherein FIG. 1A shows the front side of the seat ventilation device of the present invention, FIG. 1B shows the rear side of the seat ventilation device of the present invention.

FIGS. 2A and 2B are schematic drawing showing the structure of a second embodiment of the seat ventilation device of the present invention, wherein FIG. 2A shows the front side of the ventilation device of the present invention, FIG. 2B shows the rear side of the ventilation device of the present invention.

FIG. 3 is a schematic drawing showing the structure of the ventilated seat of the present invention.

The reference numbers in the figures refer to the following structure: 1—seat body leather cover layer, 2—3D connecting layer, 3—foam layer, 4—ventilating duct, 5—fan system, 6—air inlet and 7—air outlet.

### DETAILED DESCRIPTIONS OF THE INVENTION AND EMBODIMENTS

In combination with figures and embodiments hereunder provided, the technical solutions of the present invention are specifically described. The embodiments implemented based on the technical solution of the present invention is not meant to limit the scope of the present invention. The embodiments of the present invention as described are some embodiments of the present invention, and do not mean to cover all of the embodiments of the present invention. Based on the embodiments of the present invention, all other embodiments obtained by those skilled in the art without making creative work fall within the scope of protection of the present invention.

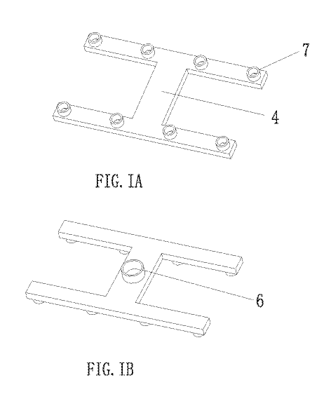

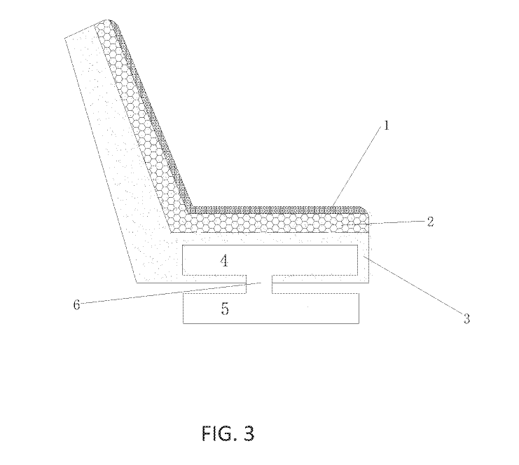

In the first embodiment of the present invention as shown in FIGS. 1A, 1B and 3, the seat ventilation device of the present invention comprises a foam layer 3 and a ventilating duct 4, the air outlet 7 of the ventilating duct 4 is embedded at the lower surface of the foam layer 3, and the air inlet 6 of the ventilating duct 4 is externally connected with a fan system 5. The ventilating duct 4 is an I-shaped cavity, an air inlet 6 is arranged on one side of the I-shaped cavity, and a plurality of air outlets 7 are arranged on the other side of the I-shaped cavity. The air inlet 6 is located in the middle of the I-shaped cavity, and the plurality of air outlets 7 are evenly distributed on both sides of the I-shaped cavity.

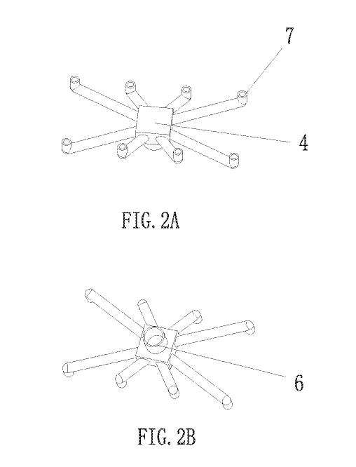

In the second embodiment of present invention as shown in FIGS. 2A, 2B, and 3, the ventilating duct 4 has an eight-claw shape and is composed of a route adapter and eight branch pipes. The central side of the route adapter is provided with an air inlet 6, one end of the branch pipe is connected to the route adapter, the other end of the branch pipe is used as the air outlet 7. In use, it is embedded in the lower surface of the foam layer 3, and the air outlet 7 and the air inlet 6 are opposite in direction.

As shown in FIG. 3, a ventilated seat comprises a seat body leather cover layer 1, a 3D connecting layer 2, a form layer 3, a ventilating duct 4 and a fan system 5. The 3D connecting layer 2 is arranged between the foam layer 3 and the seat body leather cover layer 1, and the 3D connecting layer 2 is stitched with the seat body leather cover layer 1; the ventilating duct 4 is embedded in the bottom of the foam layer 3; the upper surface of the ventilating duct 4 has air outlets 7; the lower surface of the foam layer 3 has air holes communicated with the ventilating duct 4; the air inlet 6 is at the bottom of the ventilating duct 4; the fan system 5 is connected with the air inlet 6.

The ventilated seat with a H-shaped ventilating duct of the present invention is made as follows:

Firstly, the H-shaped cavity is embedded inside the sponge when the sponge is foaming. The front/upper surface of the H-shaped cavity is provided with air outlets 7, and the lower /back surface of the H-shaped cavity is provided with an air inlet 6. The fan system 5 is connected with the air inlet 6 through a duct.

A layer of 3D connecting layer 2 is stitched under the seat body leather cover layer 1.

The seat cushion is arranged in the same way as the back.

The arrangement of the cushion of the seat is the same as the arrangement of the backrest of the seat.

It is apparent to those skilled in the art that the present invention is not limited to the details of the above-described exemplary embodiments, and the present invention can be implemented in other specific forms without departing from the spirit or essential characteristics of the present invention.

Therefore, the embodiments are to be considered as illustrative and not restrictive, and the scope of the present invention is defined by the appended claims rather than the above description. All changes that come within the meaning and range of equivalents of the claims are therefore intended to be included within the present invention. Any reference signs of appended figures in the claims should not be construed as limiting the claims.

The device of the present invention reduces the production cost, and the loss of air volume is greatly decreased, the foam has no risk of collapsing after long-term use, the ventilation area/ventilation point is flexibly arranged, there is no foreign body sensation and vibrating sensation, and the ventilation position can be arbitrarily selected according to the need.

We claim:

1. A seat ventilation device, comprising
a foam layer comprising an upper surface and a lower surface, and
a ventilating duct comprising an air inlet and an air outlet,
wherein the air outlet of the ventilating duct is embedded at the lower surface of the foam layer, and the air inlet of the ventilating duct is externally connected with a fan system.

2. The seat ventilation device of claim 1, wherein the ventilating duct is an I-shaped cavity having a first side and a second side, the air inlet is arranged on the first side of the I-shaped cavity, and a plurality of the air outlets are arranged on the second side of the I-shaped cavity.

3. The seat ventilation device of claim 2, wherein the air inlet is located in the middle of the second side of the I-shaped cavity, and the plurality of air outlets are evenly distributed on the two corresponding sides of the first side of the I-shaped cavity.

4. The seat ventilation device of claim 1, wherein the ventilating duct has a multi-claw shape and comprises a route adapter and multiple branch pipes;
a central side of the route adapter is provided with an air inlet, one end of the branch pipe is connected to the route adapter, other end of the branch pipe is embedded in the bottom of the foam layer as the air outlet, and the air outlet and the air inlet are opposite in direction.

5. A ventilated seat according to claim 1, comprising
the seat ventilation device of claim 1,
a seat body leather cover layer,
a 3D connecting layer, and
a fan system,
wherein the 3D connecting layer is arranged between the foam layer and the seat body leather cover layer, and the 3D connecting layer is stitched with the seat body leather cover layer;
the upper surface of the foam layer is fitted with the 3D connecting layer, and the fan system is connected with the air inlet.

6. The ventilated seat of claim 5, further comprising
a semiconductor air conditioning module,
wherein the fan system is connected with the air inlet through the semiconductor air conditioning module.

7. The ventilated seat of claim 5, further comprising
a heating layer,
wherein the heating layer is arranged between the 3D connecting layer and the foam layer.

8. The ventilated seat of claim 5, wherein the seat ventilation device is arranged at a cushion, a backrest, or both, of a seat.

9. The ventilated seat of claim 8, wherein the number of the air outlets on the cushion or the backrest is 3-10, and a diameter of the air outlet is in a range of 5 mm to 20 mm.

10. The ventilated seat of claim 5, wherein the lower surface of the foam layer is provided with air holes adapted to the air outlet.
